(19) United States
(12) Patent Application Publication
(10) Pub. No.: US 2016/0027115 A1
(43) Pub. Date: Jan. 28, 2016

(54) METHOD AND SYSTEMS FOR PURCHASING VEHICLES WHILE PROMOTING PERSONAL INVESTMENTS

(71) Applicant: Pedro J. González Román, Caguas, PR (US)

(72) Inventor: Pedro J. González Román, Caguas, PR (US)

(21) Appl. No.: 14/341,792

(22) Filed: Jul. 26, 2014

(51) Int. Cl. G06Q 40/06; G06Q 30/06

(52) U.S. Cl. CPC G06Q 40/06; G06Q 30/0621; G06Q 40/025

(57) ABSTRACT

Systems and methods wherein the sales and financing of motor vehicles are combined with the simultaneous purchase of a Personal Investment Fund by the Customer and via a Central Service Provider, under a series of conditions that promotes Customer's investment and savings using the value of the purchased vehicle and wherein the Central Service Provider contribute to invest to the Personal Investment Fund of the Customer on a monthly basis.

### FIELD OF THE INVENTION

The present invention relates to methods and systems for promoting the sales and financing of motor vehicles and combine vehicle's purchase with the simultaneous purchase of a Personal Investment Fund via a Central Service Provider. The instant invention provides methods and systems resulting in an alternative manner of purchasing and financing a new vehicle concurrent with promoting personal savings and investments.

### BACKGROUND OF THE INVENTION

The actual process of purchasing a motor vehicle requires great efforts from potential customers in finding and comparing multiples sales incentives of different nature from different dealers. The process becomes more complicated when the potential customer may find incentives from the vehicle manufactures and offers from vehicle sale related entities such as finance and insurance institutions. Thus, the decision of the customer requires an organized manner to access and analyze all the pertinent vehicle purchase information regarding incentive offers, finance and insurance terms and conditions within a given area.

On the other hand, after the vehicle financing loan has been paid, the value of the vehicle has depreciated at such degree that the owner of said vehicle has very few opportunities to maximize the value of the already paid vehicle. Thus, there is a need of maximizing the value of the already paid vehicle in a manner that improves the financial status of the owner of the vehicle.

It would therefore be useful and desirable to provide systems and methods for purchasing a vehicle and simultaneously improving the financial status of the purchaser by promoting his savings and investments.

### SUMMARY OF THE INVENTION

In view of the forgoing, systems and methods are provided for simplifying the purchase of motor vehicles via a Central Service Provider, which collect, organize and periodically actualize sales incentives, and the terms and conditions of sales vehicles. Said information is electronically stored and accessed by the personnel of the Central Service Provider, wherein potential customers may be totally aware of each incentives in a given area or location. The Customer while purchases at least two vehicles via the Central Service Provider in a consecutive manner and purchasing a personal investment fund under the terms and conditions according to the invention may maximize the value of his vehicle, once the financing loan of his car has been paid. Furthermore, he also received a series of benefits from the Central Service Provider directed to maximize the funds in his personal investment fund.

### BRIEF DESCRIPTION OF THE DRAWINGS

The nature and objects of the present invention and its advantages will be more clearly and easily understood after reading the following non-restricted description of preferred embodiments thereof, made with reference to the following drawings, in which: FIG. 1 illustrates a block diagram of a system according to the instant invention, wherein information regarding vehicle sales and its incentives is collected from diverse sale related entities and further organized and periodically actualized.

FIG. 2 illustrates a block diagram of an illustrative system according to the instant invention, wherein the main steps of the process according to an embodiment the invention are shown.

FIG. 3 illustrates a block diagram showing a preferred distribution of the total income obtained from the sale of the first vehicle after the financing of said vehicle has been paid and previous to the purchase of the second vehicle from the Central Service Provider.

### DESCRIPTION OF THE PREFERRED EMBODIMENTS

System and methods are provided for an alternative manner of purchasing and financing a vehicle via a Central Service Provider, an entity that acts as an intermediate between Customers and the commonly known agencies related to the sale and financing of motor vehicles; particularly dealerships, financial agencies, insurance agencies and vehicles manufacturers. Said systems and methods are herein described with reference to FIGS. 1-3.

As used herein, the terms “motor vehicle” or “vehicle” refers to a new, or previously used motor vehicle with manufacture's guarantee, such as automobiles, motorcycles, boats or any other machines, used in the motorized transportation, wherein such transportation may be made by land, air or waterway. In a preferred embodiment of the invention said motor vehicle is a new or not previously owned.

As illustrated in FIG. 1, the Central Service Provider 110, is an entity responsible for the services of promoting, insuring, financing and purchasing motor vehicles in a new organized manner and within a given location or local area. In order to complete its targets services, the Central Service Provider 110 is responsible of collecting and organizing electronically an inventory with all the information concerning a motor vehicle on sale from dealers 106 of a given area or location, thus creating and maintaining a central database. Said database is periodically updated as a routine maintenance process in order to reflect the real deals on the market of said given regional area. The collected and organized information may be operated in a particular and predefined manner using a computer readable storage medium that may tangibly embody a program, functions, and/or instructions directed to operate said information in said particular manner. Those skilled in the art will appreciate that the information collected in said main database may be organized, accessed and periodically actualized by means of suitable software and hardware.

Regarding each vehicle make, model and design from a given dealers 106, the database also includes all types of sale incentives provided by the dealer 106 owning the vehicle as well as incentives offered directly from the vehicle manufacturer 105, such as purchaser's bonus, car maintenance services and the like. Likewise, the database also includes financing and insuring offers or incentives from different finance 107 and insurance 108 entities for each vehicle respectively. Thus, for each vehicle type identified by its make, model and design, the database provides different packages of incentives and all the financial and insurance information from one or more dealers 106. Said information may be access by the Central Service Provider personnel, via internet or any other wire or wireless method in such a manner that said personnel may disclosed to any potential customer the information regarding the vehicle purchase in an organized wide and detail manner in order to help said potential customer to select and/or decide which vehicle he wants to purchase and the corresponding financing, insurance and other sales conditions without the customer need of visiting different dealers, financial or insurance entities. Thus, all the required information regarding the selection of a given vehicle, such as incentives offers, financing and insurance information may be found in a single place, saving time and efforts to the potential customer as well as increasing and facilitating vehicle sales from the dealerships. Similarly, it increases or foments the opportunities of finance and insurance institutions and motivates a healthy competition among said institutions and car dealerships. The Central Services Provider 110 has a physical location wherein potential customers would also be able to access the main database and get personal assistance or even have the opportunity of becoming a customer after completing the new vehicle purchase process. Additionally, the Central Service Provider may has its own vehicles and acts as a Dealer to the Potential Customer, who has the options to buy the vehicle directly from the Central Service Provider or any other dealer in the local area.

Regarding the vehicle purchase process itself, the Potential Customers must purchase the vehicle from or through the Central Services Provider 110 and further pay a service fee or commission payment to said Central Service Provider 110 in order to receive the benefits found in the database and other benefits described herein below and under the business terms and conditions detained below.

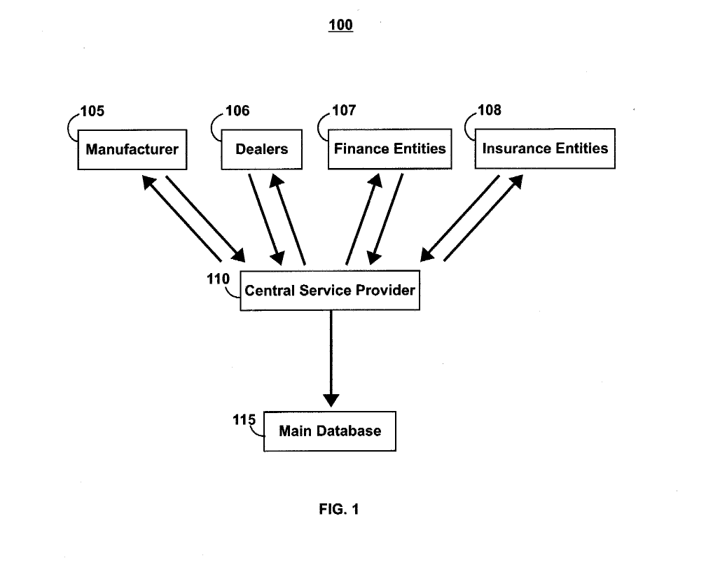

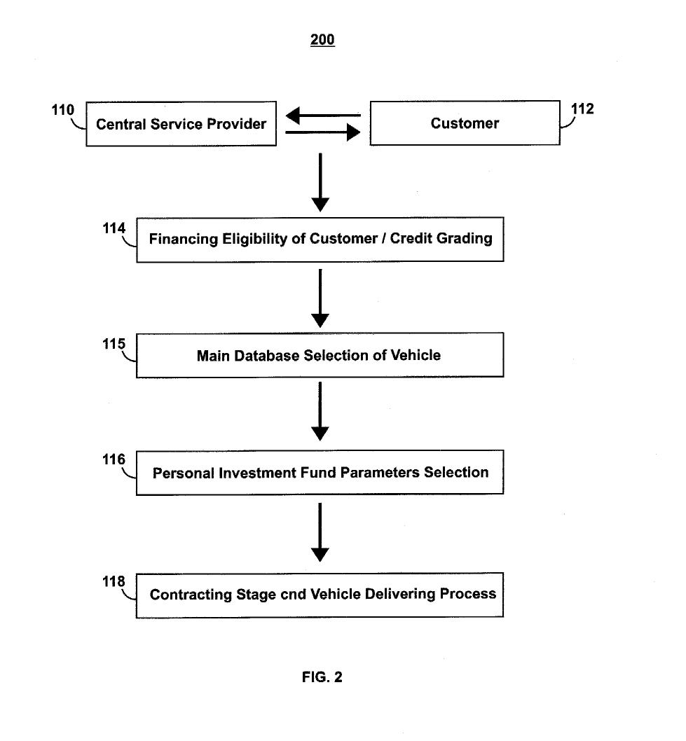

As illustrated in FIG. 2, in first place, the potential customer 112 must satisfy the financing evaluation or credit grading from the Central Service Provider 110 in order to become a Customer. Furthermore, the potential customer must compromise himself to purchase at least two vehicles from the Central Service Provider in a consecutive manner. Potential customer 112 may select 114 the vehicle he wants to purchase from the main database 115, which contains the purchase incentives and the terms and conditions of said purchase. In the preferred embodiment of the invention, such vehicles are new or not previously owned. The potential customer 106, simultaneously to the purchase of the first vehicle must acquire a Personal Investment Fund 116. Said personal investment fund has a time limit minimum of 6 years from the date of the first vehicle purchase. The Potential Customer 112 will deposit funds into said Personal Investment Fund in a monthly basis and for a predetermined amount of months. The total amount of money to be invested in said fund as well as the amount of the monthly deposits to be deposit in said fund are decided by the potential customer 112. The Potential Customer must allow the investment of the money in the free market under the professional recommendations that he freely selects and said investment is made under the customer's own risks.

As a benefit to the Customers, the Central Service Provider will provided or invest in a monthly basis and in favor of the Customer one percent (1.00%) of the monthly investment made by the Customer to the Personal Investment Fund during the financing period of the first purchased new vehicle. The Central Service Provider will provide or invest monthly and in favor to the Customer one and a quarter percent (1.25%) of the monthly amount invested by the Customer to his personal Investment Fund during the financing period of the second purchased vehicle bought in a consecutive manner by the Customer.

Simultaneously to the purchase of the vehicle, the Customer must also purchase the vehicle insurance through the Central Service Provider, said insurance being part of the incentives or offers included in the incentive package found in the main database of the Central Service Provider.

Regarding the financing process, the customer must finance the vehicle for a period of at least 6 years and a maximum of 8 years. The financing terms and conditions are part of the incentives included in the incentive package found in the main database of the Central Service Provider.

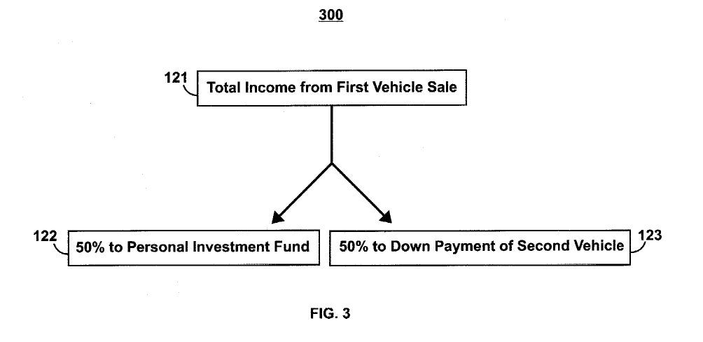

As illustrated in FIG. 3, in one embodiment of the invention, once the Customer has concluded to pay the financing loan of the first purchased vehicle, he is committed to sell said first vehicle at the price dictated by the market, said price being determined by known official standards. However, in case that the vehicle conditions has depreciated below said standard price due to the lack of maintenance of the vehicle or to the negligence of its owner, the Customer must provide the remaining amount of money until said standard value of the vehicle is satisfied. In this manner, the cost of sale the vehicle in the market is always warranted. The sale terms of the first vehicle may be coordinated via the same financial entity that provided the financing loan for the purchase of said first vehicle.

As a term or condition of the instant method, the entire amount of money generated by the sale of the first vehicle 121 must be invested in the Personal Investment Fund of the Customer. The Customer has the option of investing the whole amount 121 in his Personal Investment Fund immediately after the first vehicle is sold. Alternatively, the amount of money generated by the said sale of the first vehicle may be divided in two partial amounts as illustrated in FIG. 3. First partial amount 122 must be deposited or invest in his Personal Investment Fund 116 and the second partial amount 123 must be used as or included in the down payment of the purchase of a second new vehicle through the Central Service Provider 110. The percent of the first 122 and second 123 amount may vary depending on the Customer decision and needs; nonetheless, the total amount 121 must be distributed between the Personal Investment Fund and as a down payment in the purchase of the second vehicle. Said second vehicle would be preferable a new vehicle. As a result of including the second potion 123 as a down payment, the amount of quantity of money to be financed in the second vehicle decreased and thus the monthly financing payments directed to pay the second vehicle also decreased. Such amount of money saved due to the down payment 123 must be added or invested by Customer in a monthly rate to his Personal Inversion Fund. In this manner, the total amount of money 121, resulted from the sale of the first vehicle would be eventually included in the Personal Investment fund of the Customer. In this manner the depreciation value of the first vehicle is transformed into savings of the Customer and simultaneously in an incentive to buy a new or practically new vehicle, thus promoting vehicle manufacturing and sales.

On the other hand, the monthly investments from the Central Services Provider to the Customer's Personal Investment Fund and in favor to the Customer also increase to 1.25% of the monthly Customer's investment to said personal Investment Fund. Said investments from the Central Service Provider to the personal investment fund of the Customer are deposited in said fund during the period that Customer is paying the financing loan of the second new vehicle. In this manner, the amount of money in the Personal Investment Fund of the Customer increases or is maximized in part based on the depreciation value of the first vehicle.

Once the Customer has concluded to pay the financing loan of the second vehicle, he may choose to sell said second vehicle and purchase a third vehicle under the terms and conditions illustrated in FIG. 3, as already described. In a preferred embodiment of the invention such third vehicle is a new, not previously owned. If the Customer select said option, the second vehicle must be sold at the price on the market, the money obtained from such sale must be distributed in the same manner that the money obtained in the sale of the first vehicle in order to maximize the amount of money in the Customer Personal Investment Fund and to decrease the monthly payments of the financing loan of the third vehicle. If such option is selected by the Customer, the Central Service Provider will increase the monthly investment to the Customer Personal Investment Fund to one and a half percent (1.50%).

Alternatively, after the payment of the financing loan of the second vehicle, the Customer may decide to conclude his business relationship with the Central Service Provider and freely decides what to do with the money accumulated on his Personal Investment Fund and the inversions thereof. In such case, the Customer could also decides to continue with his monthly investments to his personal investment fund, without any commitment or investments from the Central Service Provider to said Personal Investment Fund. In case a Customer may not respond to his financial obligations of the methods and systems herein disclosed, his Personal Investment Fund or any other Customer property may serves as collateral to respond to the financial obligations contracted with the Central Service Provider.

A person that may already bought a vehicle may also become a customer of the Central Service Provider and received the benefits described above after refinancing his vehicle and his car loan through the Central Service Provider.

In general terms, in this alternative business method, the Customer must committed himself to purchase at least two vehicles, preferably new vehicles, in a consecutive period of time and to the financing terms and conditions with the Central Service Provider already discussed herein and to maintain a Personal Investment Fund during the payment of the financing loans obtained to finance the purchase of said vehicles. The above terms and conditions disclosed previously are implemented by following the particular process, wherein:
a) Central Service Provider provides a main database, which is electronically available to the Potential Customers via personnel of the Central Service Provider and wherein the Potential Customers may find a detailed disclosure of sale conditions or incentive packages for each make, model and design of vehicles. Such incentive packages includes at least dealerships incentives, financing and insurance incentives or offers and vehicle manufacture incentives in a manner that the Potential Customer is totally informed and aware of all the offers in the market for different dealerships, finance and insurance entities in the area.
b) From the main database provided, Potential Customers are able to freely decide at their own convenience the new vehicle, the financing, insuring and all other terms and conditions subjected to the purchase of the vehicle.
c) Potential Customers must provide to the personnel of the Central Service Provider their personal identification, employment status, and credit/financing status in order to verify and grading the customer credit status immediately.
d) If a given Potential Customer qualifies for the business relationship offered by the Central Service Provider and is willing to become a Customer, the Central Service Provider proceeds with providing and explaining to the Customer the terms and conditions of the business as explained previously and to confirm the selected incentive package selected by the Customer; including particularly the total price of the vehicle and the vehicle financing loan and vehicle insurance terms and conditions found in the incentive packages selected by the Customer.
e) The Customer decides the total amount he decides to invest in his Personal Investment Fund and the amount of money he commit to invest as monthly payments to said personal investment fund.
f) The Customer and the Central Service Provider sign the corresponding sales contract, wherein all the terms and conditions of the sale are indicated.
g) The Central Service Provider contacts the corresponding dealership in order to arrange the delivery of the purchased vehicle to the Customer.
h) Customer and Central Service Provider follow up in their mutual committed rights and responsibilities already disclosed until the financing loan of the first vehicle is paid and sold and the money obtained is redistributed as indicated previously.
i) Customer selects second vehicle from the main database and proceeds with the purchase of the second vehicle via the Central Service Provider and under the terms and conditions disclosed above.

It should be understood that the steps on the flow diagram illustrated in FIGS. 1 and 2 are merely illustrative. Any of such steps may be changed or modified, omitted, or rearranged, some of them may be combined, or any additional steps may be included or added, without departing from the scope of the instant invention. Similarly, it will be understood that the foregoing is only illustrative of the principles of the invention, and that various modifications may be made by those skilled in the art without departing from the scope and spirit of the invention. Indeed, those skilled in the art will appreciate that the invention may be practices by others than the described embodiments, which are presented for purpose of illustrating rather than of limitation, and the invention is limited only by the claims that follow.

What is claim is:

1. A method for purchasing at least two vehicles in a consecutive manner and in financing terms from a Central Service Provider, said method comprising:
a) potential customer electronically gain access to a main database prepared by the Central Service Provider, said database comprising for a given make, model and design an organized choices of incentive packages wherein each incentives packages includes incentives from the vehicle manufactures, vehicle dealership, insurance entity and finance institution;
b) potential customer free selection of the desired make, model and design vehicle and the corresponding incentive package from said main database;
c) Central Service Provider verification of potential customer identification and potential customer credit status grading;
d) Central Service Provider approval or disapproval potential customer as a customer based upon said credit grading;
e) Customer selection and acquisition of a personal investment fund simultaneously to the purchase of the first vehicle;
f) purchasing of the vehicle through the Central Service Provider, wherein the finance loan and insurance terms and conditions of the purchase vehicle are established as indicated in the main database of the Central Service Provider;
g) Central Service Provider invests 1.00% percent of the total monthly payment to the personal trust fund of the customer in a monthly basis during the finance loan payment period of the first vehicle;
h) after paying the financing loan, customer sale of first vehicle;
i) Customer new selection of a second vehicle from the main catalogue of the service provider;
j) Customer purchase of a second vehicle under financing terms;
k) Customer continue to monthly invests in his personal investment trust during the payment of the finance loan of the second purchased vehicle and
l) Central Service Provider invests 1.25% of the total monthly payment to the personal trust fund of the customer in a monthly basis during the finance loan payment period of the second vehicle.

2. The method as recited in claim 1, wherein the first and second vehicles are new vehicles or not previously owned vehicles.

3. The method as recited in claim 1, wherein the customer after paying the financing loan of the first vehicle provides to the Central Service Provider the cost of said first vehicle at the market price.

4. The method as recited in claim 2, wherein 50 percent of the money obtained in the sale of the first vehicle is invested in the down payment of the purchase of the second vehicle, thus decreasing the finance loan monthly payments of the second vehicle.

5. The method as recited in claim 2, wherein 50 percent of the money obtained in the sale of the first vehicle is deposited as an investment in the customer's personal investment fund, thus increasing the amount of money of the customer personal investment fund.

6. The method as recited in claim 2, wherein the amount that customer invests to this personal investment fund increase after the sale of the first vehicle by the same amount of money decreased in the monthly loan payments due to the 50 percent used as down payment in the purchase of the second vehicle and obtained from the sale of the first vehicle.

7. The method as recited in claim 1, wherein the customer purchase a third vehicle following the same steps used to purchase the second vehicle after payment of the financing loan used to pay the second vehicle.

8. The method as recited in claim 6, wherein after the purchase of a third vehicle following the same steps used to purchase the second vehicle after payment of the financing loan used to pay the second vehicle, the monthly investments of the Central Service Provider to the customer personal investment fund is increase to 1.50% of the monthly investments deposited by the customer in said fund.

9. The method as recited in claim 1, wherein the customer purchase a third vehicle following the same steps used to purchase the second vehicle after payment of the financing loan used to pay the second vehicle.

10. The method as recited in claim 1, further comprising that, after the customer has paid the financing loan used to pay the second vehicle, the customer is free to use his personal fund trust without any intervention from the Central Service Provider.

11. The method as recited in claim 1, wherein the vehicle is land transport vehicle.

12. The method as recited in claim 11, wherein the vehicle is an automobile.

13. The method as recited in claim 11, wherein the vehicle is a motorcycle.

14. The method as recited in claim 1, wherein the vehicle is an air transportation vehicle.

15. The method as recited in claim 1, wherein the vehicle is a maritime transportation vehicle.
